(19) United States
(12) Patent Application Publication
(10) Pub. No.: US 2024/0154570 A1
(43) Pub. Date: May 9, 2024

(54) MODULE COUPLING CLAMP

(71) Applicant: PEGASUS SOLAR, INC., Richmond, CA (US)

(72) Inventors: Erich Kai Stephan, Richmond, CA (US); Ian Wogan, Richmond, CA (US); Ian Lennox, Richmond, CA (US); James Hsieh, Richmond, CA (US)

(21) Appl. No.: 18/386,912

(22) Filed: Nov. 3, 2023

Related U.S. Application Data
(60) Provisional application No. 63/459,975, filed on Apr. 17, 2023.
(60) Provisional application No. 63/422,085, filed on Nov. 3, 2022.

(51) Int. Cl. H02S 30/10; F16B 5/00

(52) U.S. Cl. CPC H02S 30/10; F16B 5/0072

(57) ABSTRACT

A coupling clamp is provided that includes a top clamp and a bottom clamp. The top clamp may include a top vertical flange and a top lateral flange. The bottom clamp may include a bottom vertical flange and one or more bottom lateral flanges that extend laterally in opposite directions. At least one of the bottom lateral flanges may include a first portion having a surface configured to engage with a solar module and a second portion connected to the bottom vertical flange at an intersection below the surface of the first portion. The coupling clamp may be installed onto one or more solar modules that are positioned onto a rail that has an installed rail clamp. Another solar module may be positioned on the coupling clamp and rail and then slid under the rail clamp, which may be tightened to secure the other solar module to the rail.

### CROSS-REFERENCE TO RELATED APPLICATIONS

The present patent application claims the priority benefit of U.S. provisional patent application 63/422,085 filed Nov. 3, 2022 and U.S. provisional patent application 63/459,975 filed Apr. 17, 2023, the disclosures of which are incorporated by reference herein.

### BACKGROUND OF THE INVENTION

### 1. Field of the Disclosure

The present disclosure generally relates to solar module clamps. More specifically, the present disclosure relates to module coupling clamps for clamping solar modules.

### 2. Description of the Related Art

Currently, solar modules are typically installed onto a series of beams, often called rails. The solar modules may not connect to one another between rows of solar modules, and if they do, a clamp may be used that is difficult to secure.

There is, therefore, a need in the art for improved solar module clamps and methods for installing solar modules using the solar module clamps.

### SUMMARY OF THE CLAIMED INVENTION

The present invention demonstrates a more ergonomic and user-friendly design to clamp adjacent solar modules together. A coupling clamp is provided that includes a top clamp and a bottom clamp. The top clamp may include a top vertical flange and a top lateral flange. The bottom clamp may include a bottom vertical flange and one or more bottom lateral flanges that extend laterally in opposite directions. At least one of the bottom lateral flanges may include a first portion having a surface configured to engage with a solar module and a second portion connected to the bottom vertical flange at an intersection below the surface of the first portion. The coupling clamp may be installed onto one or more solar modules that are positioned onto a rail that has an installed rail clamp. Another solar module may be positioned on the coupling clamp and rail and then slid under the rail clamp, which may be tightened to secure the other solar module to the rail.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIGS. 1A, 1B, and 1C respectively depict isometric top-down, bottom, and side views of a coupling clamp in an example embodiment of the present invention.

FIGS. 2A and 2B respectively depict a side and close-up view depicting a coupling clamp in an example embodiment of the present invention.

FIGS. 3A and 3B respectively depict an end view of a coupling clamp with an example profile of a frame of a first solar module during different stages of installation.

FIGS. 3C through 3E further respectively depict an end view of a coupling clamp with an example profile of a frame of a second solar module during different stages of installation.

FIGS. 4A and 4B respectively depict different steps of an example method of installing one or more solar modules using a coupling clamp.

FIGS. 5A through 5D respectively depict isometric, side, close-up, and partially exploded views of a symmetrical design of the coupling clamp in an example embodiment of the present invention.

FIGS. 6A through 6D respectively depict isometric views of an example method of installation of the coupling clamp on to one or more solar modules.

FIGS. 7A and 7B respectively depict angled top-down wider views of FIGS. 6C and 6D from an opposite perspective.

FIGS. 8A through 8C respectively depict an alternative method of installing solar modules using a coupling clamp.

FIGS. 9A through 9D respectively depict an alternative installation sequence of a fourth solar module in the second row of solar modules after a coupling clamp has been installed.

FIGS. 10A and 10B respectively depict an example height-adjustable support body releasably connected to a coupling clamp that has been installed.

FIGS. 11A and 11B respectively depict isometric, upper, and lower views of a support body connected to a coupling clamp.

FIG. 11C depicts a side view of a coupling clamp with an example support body in an upper position.

FIG. 11D depicts the same view as FIG. 11C but with the example support body in a lowered position.

FIG. 12A depicts an end view of an example solar module frame with a frame groove disposed on the outside surface of the solar module frame.

FIG. 12B depicts an isometric view of an example assembled solar module frame with a frame groove.

FIG. 13 depicts an end view of an example coupling clamp configured to engage with frame groove on a solar module.

FIG. 14 depicts an alternative embodiment where coupling clamp is configured to only engage a lower surface of frame groove and the underside first solar module and second solar module.

FIG. 15 depicts another alternative embodiment where the coupling clamp is formed as a single piece with vertical flanges.

FIGS. 16A and 16B respectively depict an alternative embodiment of a support base that includes one or more roof fasteners configured to secure the support base to a roof surface.

FIGS. 17A and 17B respectively depict a first side view and a top-down view of the coupling clamp configured to engage a frame groove.

FIGS. 18A and 18B respective depict a second side view and an isometric view of the coupling clamp of FIGS. 17A and 17B.

FIG. 19 depicts an isometric view close-up of a first solar module and third solar module in a first row of solar modules, and a second solar module in a second row of solar modules.

FIG. 20 is an isometric view of a coupling clamp with a slidable support foot, representing another example embodiment of the present invention.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

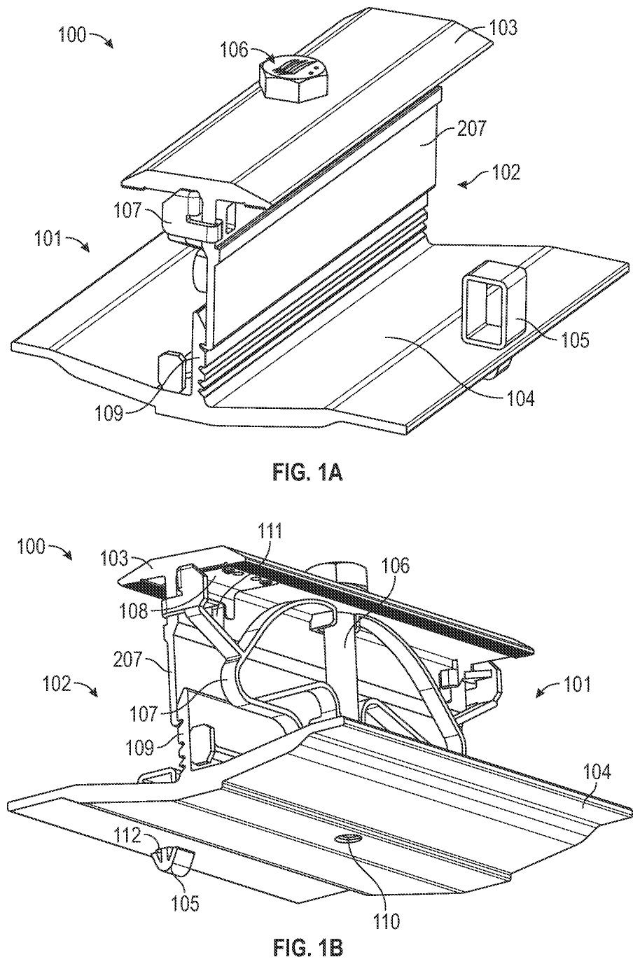

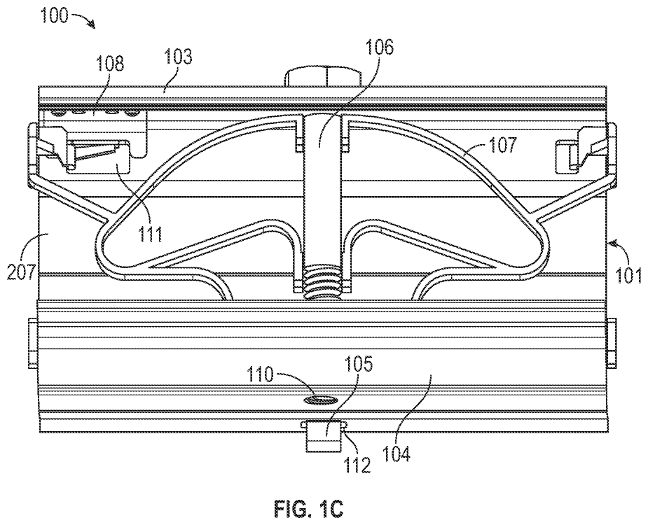

FIGS. 1A, 1B, and 1C depict isometrics upper, lower, and side views representing an example embodiment of the present invention. Coupling clamp 100 may be comprised of a top clamp 103, a bottom clamp 104, forming a first engagement side 101 and a second engagement side 102. In some example embodiments, such as shown in FIGS. 1A through 1C, the coupling clamp 100 may also have a fastener 106, a resilient flexible member 107, a bond feature 108 and a spacer 105. In various embodiments, there may be zero, one, or multiple fasteners 106, resilient flexible members 107, and/or spacers 105.

Top clamp 103 may have a uniform cross-sectional geometry along its entire length, except for one or more laterally disposed apertures. Bottom clamp 104 may have a uniform cross-sectional geometry along its entire length, except for one or more laterally disposed apertures. Both top clamp 103 and bottom clamp 104 may be constructed of aluminum, steel, stainless steel, a polymer, or other suitable materials. Both top clamp 103 and bottom clamp 104 may be manufactured by extrusion, stamping, progressive die, casting, roll forming, injection molding, additive metal manufacturing, milling, or other suitable processes.

A threaded aperture 110 may be disposed through the body of the bottom clamp 104, substantially tangent to one or more bottom vertical flange 109. The threaded aperture 110 may be configured to threadably engage a fastener 106, which traverses the top clamp 103 towards the bottom clamp 104 when rotated and tightened. Resilient flexible member 107 may be configured to support the top clamp 103 in position above the bottom clamp 104 against the force of gravity, as well as configured to flex when the top clamp 103 is pushed down by the tightening of the fastener 106.

As shown in FIG. 1C, a bond feature 108 may be offset to the left side of the top clamp 103. In other examples, the bond feature 108 may be located at the mid-point along the length of the top clamp 103 or offset to the right side of the top clamp 103. The bond feature 108 may be positioned along the length of the top clamp 103 at a distance away from the rotation axis of the fastener 106 to prevent the coupling clamp from disengaging on a first engagement side 101 when the fastener 106 threadably engages with threaded aperture 110. The bond feature 108 may be made from a metal plate, such as a piece of sheet metal of substantially uniform thickness and may have one or more protrusions disposed on its surface. The protrusions of the bond feature 108 may be configured to pierce the coating of a solar module frame. The top clamp 103 may have a bond plate aperture 111 disposed laterally through top vertical flange 207. The bond feature 108 may be configured to partially traverse through the aperture in order to position one or more protrusions against the underside of the top clamp 103 on either side of the top vertical flange 207. In other example embodiments not shown, the bond feature 108 may be a cylindrical pin pressed into the underside of the top clamp 103. A pin-style bond feature 108 may employ a pin on just one quadrant of the top clamp 103 as viewed from below or on more than one quadrant. In other words, the pin-style bond feature 108 may be positioned along the length of the top clamp 103 at a distance away from the rotation axis of the fastener 106 to prevent the coupling clamp from disengaging on a first engagement side 101 when the fastener 106 threadably engages threaded aperture 110.

The bond feature 108 may be made from a material with a hardness greater than the frame of a solar module. In this way, protrusions on the bond feature 108 may pierce the coating disposed on the frame of a solar module in order to create an electrical bond path between a first solar module and the coupling clamp, and in some cases, also a second solar module. In an example method, the frame of a solar module may be compressed between the bottom clamp 104 and the bond feature 108, the bond feature 108 being compressed by the top clamp 103 when a fastener 106 engages the threaded aperture 110.

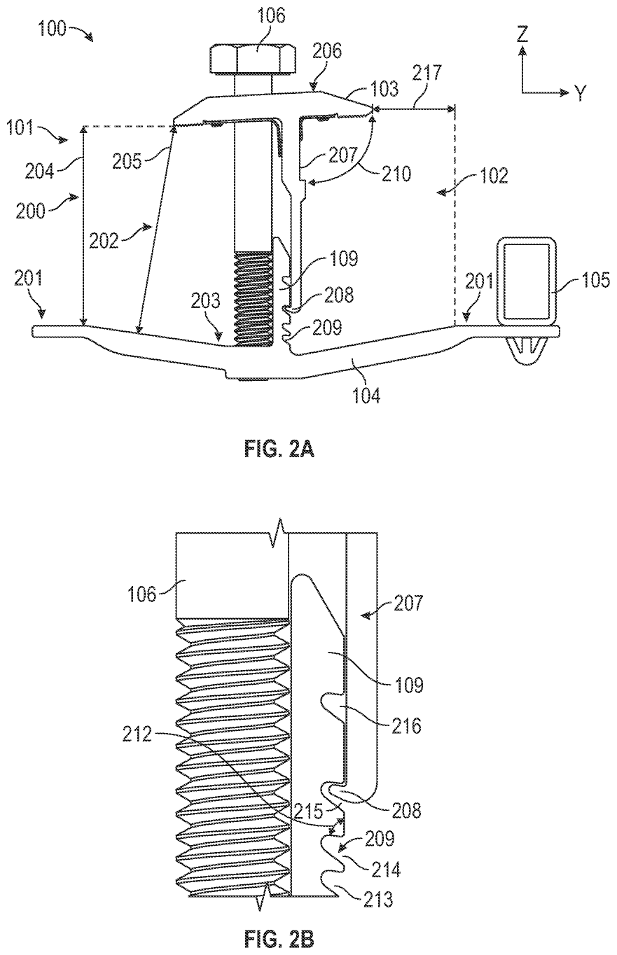

FIG. 2A is a side view depicting an example embodiment of the present invention with the resilient flexible member 107 hidden for improved visibility of other components. As illustrated, coupling clamp 100 may be assembled from top clamp 103, bottom clamp 104, fastener 106, spacer 105, and resilient flexible member 107 (hidden). Bottom clamp 104 may have a portion that includes a module flange 201 on both a first engagement side 101 and a second engagement side 102. A surface plane of the module flange 201 may be perpendicular to the length of fastener 106 (as depicted) or may be set at an angle relative to the length of fastener 106. Inclined flange 203 extends from the body of the bottom clamp 104 to the module flange 201. Inclined flange 203 may be on both sides of the bottom clamp 104 (as shown) or may be only on the second engagement side 102 of the bottom clamp 104. The intersection of the inclined flange 203 with the body of the bottom clamp 104 may be lower in the z-direction (e.g., vertical) than a surface of the module flange 201. An intersection of the inclined flange 203 with the module flange 201 may also be separated from the distal end of the top lateral flange by at least a horizontal distance 217. A hypotenuse distance 202 is formed between the distal end of the top clamp 103 and the face of the inclined flange 203 on a first engagement side 101. A vertical distance 200 is measured in only the z-direction between the module flange 201 and the distal end of the top clamp 103. Inclined flange 203 intersects the module flange 201 at a distance away from the central plane of the coupling clamp 100 such that the hypotenuse distance 202 is greater than the vertical distance 200. Alternatively, horizontal distance 217 may be greater than zero.

Top clamp 103 may be comprised of a top flange 206 and top vertical flange 207. Top vertical flange 207 may connect with top flange 206 offset from the centerline of top flange 206, as shown in FIGS. 2A-2B, or in line with the centerline of top flange 206. In the example embodiment shown, top flange 206 is at angle 210 that is obtuse to the top vertical flange 207. In other words, the angle formed between the top flange 206 and the top vertical flange 207 may be obtuse on the second engagement side 102 and acute on the first engagement side 101. In other example embodiments, the top flange 206 is perpendicular to the top vertical flange 207. Top vertical flange 207 may have varying wall thicknesses down its length, may have an angled transition on the side facing the first engagement side 101, and may have protrusion facing toward the second engagement side 102 configured to cooperate with a resilient flexible member 107.

Bottom clamp 104 may have one or more bottom vertical flange 109 protruding in the positive z-direction from a main body of the bottom clamp 104. As shown in FIGS. 2A and 2B, a single bottom vertical flange 109 extends perpendicular from the body of the bottom clamp 104. In the example embodiment shown, the bottom vertical flange 109 has one or more substantially identical grooves 209 facing the second engagement side 102.

FIG. 2B depicts grooves 209 in more detail. In this example embodiment, the grooves 209 are formed from two sloped surfaces connected by a curved inner surface. The top surface forming the ceiling of the groove is at an acute first groove angle 212 as measured from the adjacent vertical surface of the bottom vertical flange 109. The lower surface forming the floor of groove 209 may be formed such that grooves 209 are tapered toward the outer surface of the bottom vertical flange 109, as shown. Tooth 208 disposed on the distal end of the top vertical flange 207 is shaped to cooperate with any one of the grooves 209. Tooth 208 has an acute angle between the top surface of tooth 208 and the top vertical flange 207, said acute angle substantially similar to the first groove angle 212. The grooves 209 may be spaced apart at even intervals, or at specific intervals as shown to correspond with common thicknesses of solar module frames. For example, FIG. 2B illustrates (starting from the bottom) a distance between 30 mm groove 213 and the top 40 mm groove 216, where the grooves 209 are spaced apart 2 millimeters, then 3 millimeters, then 5 millimeters. The engagement between tooth 208 and grooves 209 corresponds to one of a plurality of available resulting vertical distances 200. The vertical distance 200 may be adjusted so as to securely clamp solar modules of different thicknesses therebetween. For example, the clamped solar module may have frame thicknesses of 30 mm, 32 mm, 35 mm, and 40 mm, respectively.

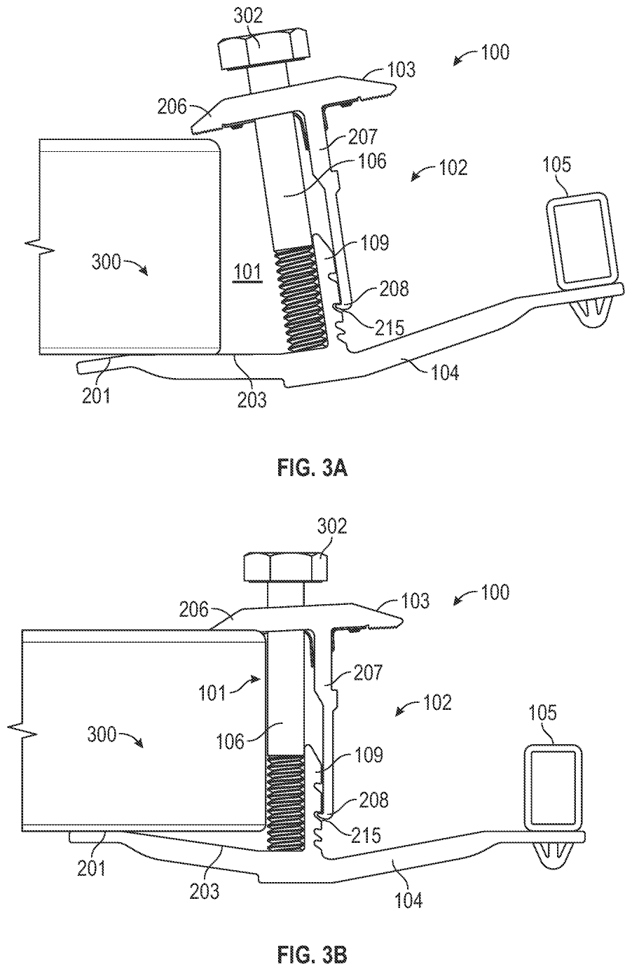

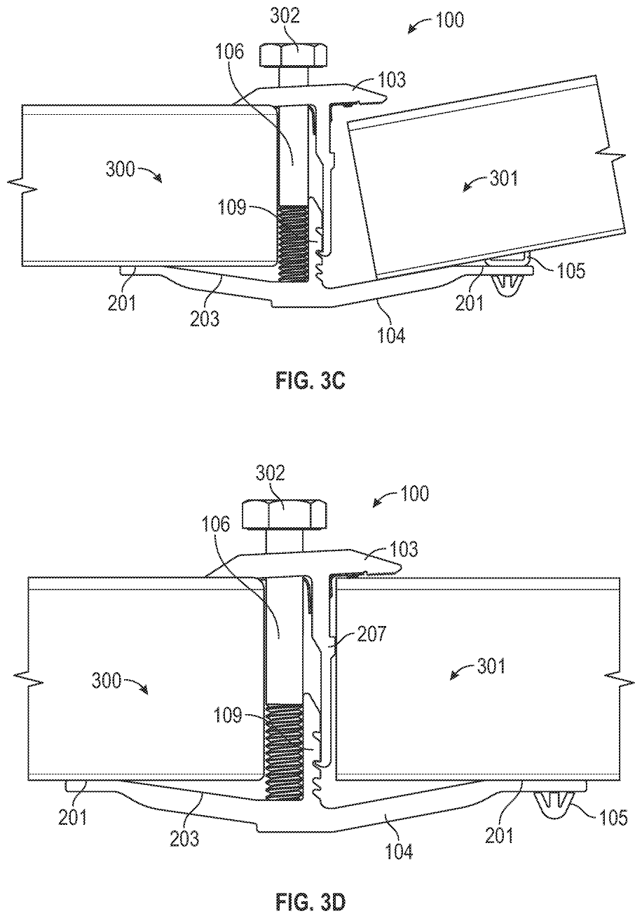

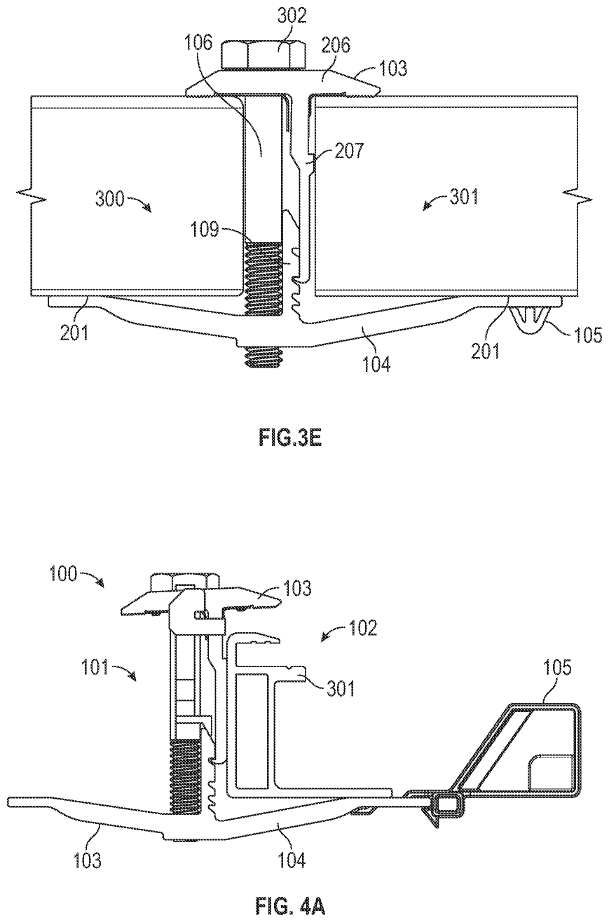

As an example of dimensions representing one example embodiment of the present invention, in referring to FIG. 2B, top clamp 103 may be positioned so that tooth 208 engages the 35 mm groove 215. The 35 mm groove 215 may be positioned at a dimension above module flange 201 such that dimension or vertical distance 200 is less than or equal to 35 mm while hypotenuse distance 202 is greater than 35 mm. In this way, as shown in FIG. 3A, the coupling clamp 100 can be slid onto a solar module 300 with a frame thickness of 35 mm when the coupling clamp 100 is at an angle so the line forming hypotenuse distance 202 is nearly parallel to an exterior surface of the solar module. Likewise, inclined flange 203 may be substantially parallel to solar module 300. After coupling clamp 100 is positioned on solar module 300 such that top clamp 103 extends over the solar module 300 by a suitable distance, (such as when the solar module 300 is nearly coincident with the body of fastener 106 as shown in FIG. 3B, coupling clamp 100 may be articulated to secure to the solar module 300 between the top clamp 103 and the module flange 201. In this example method, fastener 106 may be positioned such that the fastener head 302 is not imparting a downward force on the top clamp 103, but rather, the cooperation of the tooth 208 with the groove 209 retains the top clamp 103 to secure coupling clamp 100 when coupling clamp 100 is slid onto and then articulated onto the solar module 300 as described.

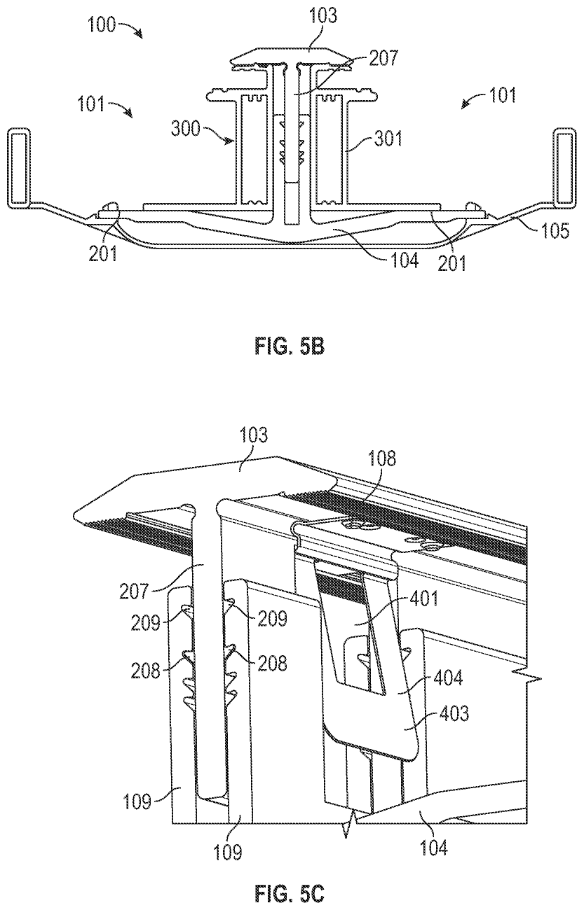

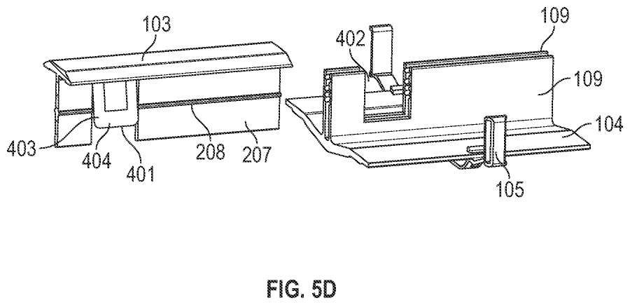

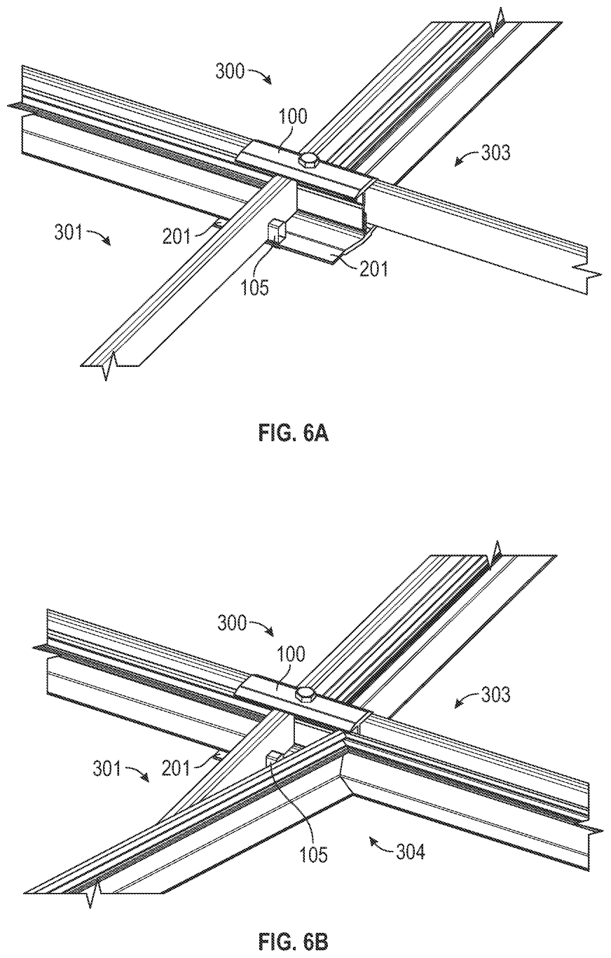

FIGS. 3A through 3E depict an example method of installation of the coupling clamp 100 to a first solar module 300 and a second solar module 301. Within FIGS. 3A through 3E, the resilient flexible member 107 has been hidden from view for easier presentation of other components, but it is envisioned that the resilient flexible member would be included in the embodiment depicted. As depicted in FIG. 3A, top clamp 103 may have been positioned so tooth 208 engaged a desired groove 209 in coordination with a known frame thickness of a solar module. Fastener 106 may or may not have been rotated or transitioned. Coupling clamp 100 may be angled so the solar module 300 is able to traverse into the first engagement side 101 without resistance until the solar module 300 is substantially coincident with fastener 106 or a bottom vertical flange 109 (e.g., from the embodiments shown in FIGS. 5A through 5D). As a potential next step, coupling clamp 100 may be articulated (e.g., rotated, transitioned) so the solar module 300 is clamped between the module flange 201 on the bottom clamp 104 and the first side (e.g., top flange 206) of the top clamp 103. In conjunction, tooth 208 may positively engage groove 209 to prevent the top clamp 103 from traversing away from the module flange 201.

FIG. 3C depicts a potential next step, wherein a second solar module 301 is positioned into a second engagement side 102 of the coupling clamp 100. The second solar module 301 may be at an angle relative to the first solar module 300 when the second solar module 301 is installed into the second engagement side 102, as shown in the figure.

FIG. 3D depicts the second solar module 301 now substantially parallel with the first solar module 300 (e.g., the primary glass surfaces of each are substantially parallel), and second solar module 301 is substantially coincident with the top vertical flange 207. In this example embodiment, the top flange 206 on the second engagement side 102 and/or the bond feature 108 may not be touching the second solar module 301, or one or both may be slightly engaged with the second solar module 301 but with a minimal amount of clamping force to still enable the second solar module 301 to slide laterally by moderate human force along the length of the coupling clamp 100 (e.g., into and out of the page).

FIG. 3E depicts the final installation state representing one example embodiment of the present invention. As illustrated in FIG. 3E, fastener 106 has engaged with threaded aperture 110 to compress onto the top clamp 103, thereby increasing the compressive force of the coupling clamp 100 onto a first solar module 300 and deflecting the second engagement side 102 of top flange 206 to impart a suitable clamping force of the coupling clamp 100 on a second solar module 301. In this example embodiment, angle 210 may reduce as top flange 206 on the second engagement side 102 is deflected down towards the second solar module 301.

In an alternative example, tooth 208 may be disposed on the distal end of the bottom vertical flange 109, and the one or more grooves 209 may be disposed along the length of the top vertical flange 207. In yet another alternative embodiment, the bottom vertical flange 109 may not have a tooth 208, and rather have a substantially flat surface configured to slide against top vertical flange 207. In this alternative embodiment, the top vertical flange 207 may also be a substantially flat surface with no grooves 209 or tooth 208, said flat surface configured to slidably engage with the flat surface of the bottom vertical flange 109. As a potential method of installation, the coupling clamp 100 may be positioned so that a solar module is in the first engagement side 101. As a second potential step, the fastener 106 may be rotated to threadably engage threaded aperture 110, thereby compressing the top clamp 103 and bottom clamp 104 onto the frame of the solar module 300. The yield strength and stiffness of the top vertical flange 207 and bottom vertical flange 109 may be such that upon tightening, the fastener 106 may sufficiently clamp the solar module 300 on the first engagement side 101, the hypotenuse distance 202 on the second engagement side 102 remains larger than the thickness of a solar module 300. Then, a second solar module 301 may be positioned at an angle into a second engagement side 102 so that the frame of the second solar module 301 is able to be positioned between the top clamp 103 and bottom clamp 104. Then the second solar module 301 may be angled down into a position substantially planar with the first solar module 300 and the second engagement side 102 sufficiently clamps the second solar module 301.

In another example embodiment (not shown), top vertical flange 207 may not have any tooth 207; instead, tooth 207 may be formed at the distal end of a flange protruding from resilient flexible member 107. In this example, tooth 207 may be configured to cooperate with grooves 209 in the same way as previously described. The flange extending from resilient flexible member 107 with tooth 207 may be flexible to readily press tooth 207 into a groove 209 as the top clamp 103 traverses towards bottom clamp 104. The flange may have a face to press or pull, such as by hand, finger, or tool, to disengage tooth 207 from a groove 209 in order to traverse top clamp 103 away from bottom clamp 104 in a substantially vertical direction.

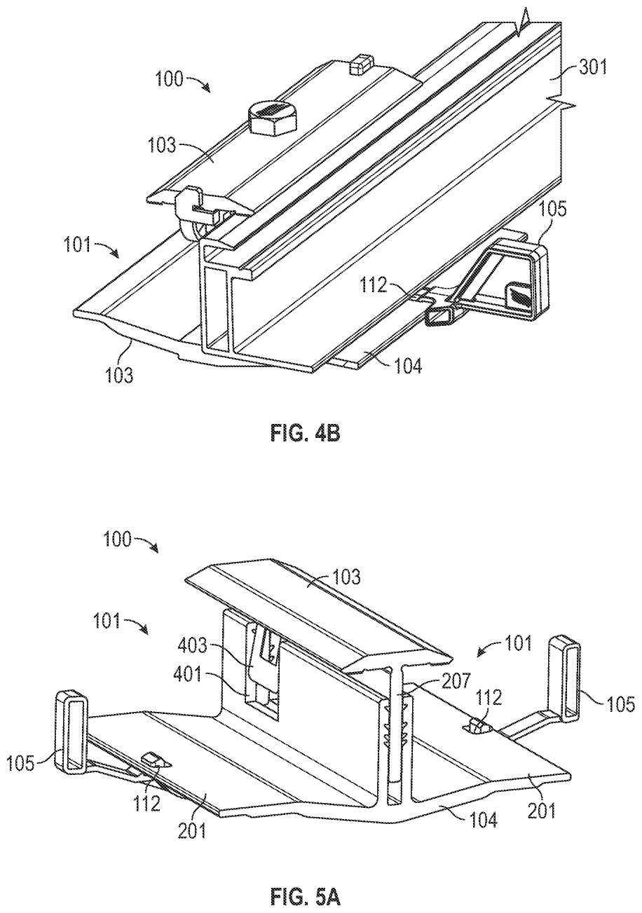

FIGS. 4A and 4B depict an end view and an isometric view of the present invention with an example profile of a frame of a second solar module 301 installed on a second engagement side 102. One or more spacer apertures 112 may be disposed through one or more module flanges 201, configured to receive a spacer 105. Spacer 105 may have a snap or locking feature configured to secure the spacer 105 to bottom clamp 104 upon assembly. Spacer 105 may be provided only on the second engagement side 102 (and not the first engagement side 101) of the coupling clamp 100, or on both the first engagement side 101 and second engagement side 102. Spacer 105 may be positioned a distance away from the bottom vertical flange 109 or the top vertical flange 207 to avoid interference with all or a portion of a second solar module 301, such as a horizontal frame member as depicted. Spacer aperture 112 may be positioned mid-way along the length of bottom clamp 104 as depicted. Spacer 105 may be made from a resilient flexible material to allow for temporary non-permanent deflection when the frame of a solar module inadvertently or intentionally comes in contact with spacer 105. Spacer 105 may have one or more apertures disposed laterally in order to reduce material usage or to allow for easy holding, such as with one's finger.

The surfaces of spacer 105 may taper from a thicker mid-section to a thinner distal edge, with the thickest section symmetrically or asymmetrically bisecting the main body of spacer 105 as shown in FIGS. 4A and 4B. In other words, in viewing a cross-section of any main member of spacer 105, the upper and lower walls may have a slope or draft forming an acute angle with the horizon.

FIGS. 5A through 5D depict a symmetrical design of the coupling clamp 100, representing an example embodiment of the present invention. As shown in FIG. 5B, bottom clamp 104 is symmetrical along its mid-plane when viewed from the end. In this example embodiment, the first engagement side 101 has identical functions as the first engagement side 101 previously described, and the second engagement side 102 is identical to the first engagement side 101. Top clamp 103 may have two teeth 208, as shown, with a pair of grooves 209 mirrored across the mid-plane of the bottom clamp 104. In this example embodiment, the fastener 106 is not present, but rather the pair of mirror-image opposing teeth 208 and grooves 209 retain the top vertical flange 207 between a pair of bottom vertical flanges 109 protruding up from the Bottom clamp 104. In an alternative example, one or more teeth 208 may be disposed on the distal end of one or more bottom vertical flanges 109, and the one or more grooves 209 may be disposed along the length of the top vertical flange 207.

One or more apertures 401 and 402 may be disposed laterally through the top vertical flange 207 and through one or more bottom vertical flanges 109, as shown in FIGS. 5A, 5C, and 5D. The top clamp lateral aperture 401 may have substantially the same width as the bottom clamp lateral aperture 402. The top clamp lateral aperture 401 may be positioned from one end of the top clamp 103 a substantially similar distance as the bottom clamp lateral aperture 402 is positioned from a like end of the bottom clamp 104. In this way, when a first end of a top clamp 103 and first end of a bottom clamp 104 are substantially coincident, the top clamp lateral aperture 401 and the bottom clamp lateral aperture 402 are also substantially aligned.

A locking flexible member 403 may be secured to the top clamp 103 by a compression or interference fit. The locking flexible member 403 may have a locking flange 404 extending from its main body so that a portion is within the thickness of the top vertical flange 207 of the top clamp 103 and a portion is within the thickness of one or more of the bottom vertical flanges 109, as shown in FIG. 5C. In this position, a side edge of the locking flange 404 would interfere with the exposed surface of the top clamp lateral aperture 401 and the bottom clamp lateral aperture 402, thereby preventing the top clamp 103 from traversing along the length of the bottom clamp 104. Further, the top clamp 103 would be substantially secured by the engagement of one or more teeth 208 and grooves 209 in the z-direction, by the wall-to-wall interference between the top vertical flange 207 and one or more bottom vertical flanges 109 in the y-direction, and by the locking flange 404 in the x-direction.

As an example method to set the top clamp 103 at a different height away from the bottom clamp 104, e.g., for use on a different thickness frame solar module, the locking flange 404 may be non-permanently deflected toward the centerline of the bottom clamp 104 such that the side edge of the locking flange 404 is clear of a first bottom vertical flange 109. In this way, the locking flange 404 no longer prevents the top clamp 103 from traversing in the x-direction relative to the bottom clamp 104. As a potential next step, upon the top clamp 103 being fully removed from the bottom clamp 104, as shown in FIG. 5D, the teeth 208 are aligned with the desired pair of grooves 209, and top clamp 103 is traversed back into the bottom clamp 104 until the top clamp lateral aperture 401 and the bottom clamp lateral aperture 402 are substantially aligned. The locking flexible member 403 may then be flexed to prevent the top clamp 103 and bottom clamp 104 from further traversing in the x-direction.

In some example embodiments, the locking flexible member 403 may also have bond features 108 disposed on lateral flanges on the underside of the top clamp 103, as shown in FIG. 5C. These bond features 108 would act in the same way as previously described in the other example embodiments.

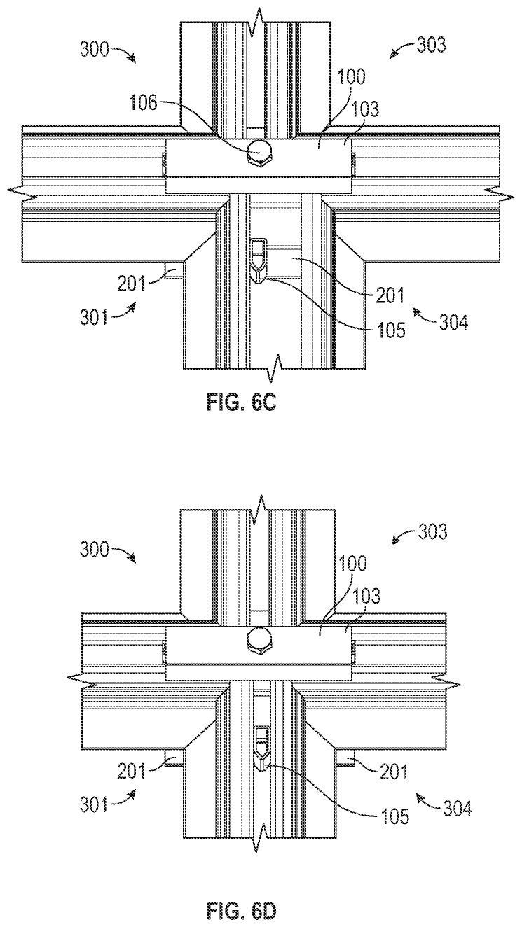

FIGS. 6A through 6D depict isometric views of an example method of installation of the coupling clamp 100 onto one or more solar modules. As depicted in this example, a first solar module 300, second solar module 301, and third solar module 303 may already be installed onto one or more rails (not shown). FIG. 6A depicts a coupling clamp 100 installed onto a first solar module 300 and third solar module 303 on a first engagement side 101, and a second solar module 301 on a second engagement side 102. In this example embodiment, spacer 105 extends about halfway up the thickness of a solar module frame. In this example, coupling clamp 100 is positioned so that spacer 105 is substantially coincident with the side frame section of the second solar module 301. In FIG. 6B, a fourth solar module 304 is installed into the second engagement side 102, in a step similar to that described for FIG. 3C. FIG. 6C depicts an angled top-down view where the fourth solar module 304 has been lowered so its top surface (e.g., the glass) is now substantially parallel to the third solar module 303, similar to the description for FIG. 3D. As a potential next step, as depicted in FIG. 6D, the fourth solar module 304 may be moved laterally along the length of the coupling clamp 100 until substantially coincident with spacer 105. Then, fastener 106 may be tightened to secure all four solar modules engaged with the coupling clamp 100.

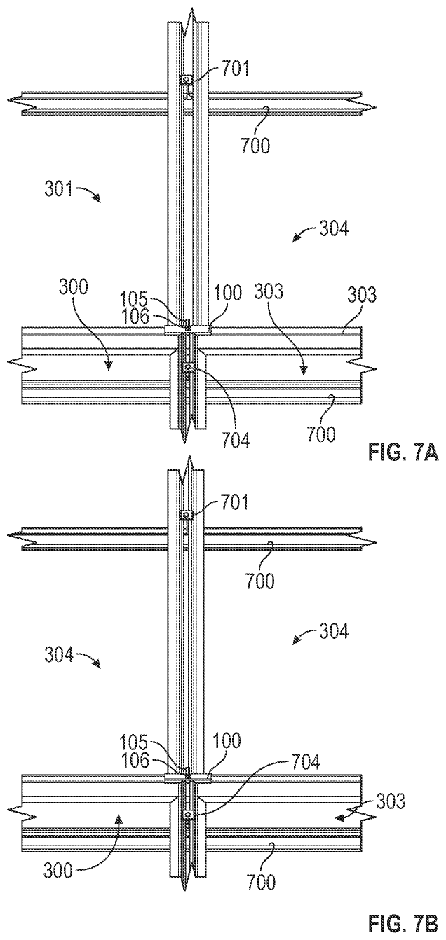

FIGS. 7A and 7B depict angled top-down wider views of FIGS. 6C and 6D from the opposite perspective in which solar module one 300 and solar module three 303 are on the lower half of the respective figure. A third rail clamp 701 may be installed into a rail 700 and positioned to clamp over the side of a second solar module 301. As shown in FIG. 7A, the fourth solar module 304 may be lowered when it is spaced away from a second solar module 301 to avoid interference with third rail clamp 701. In FIG. 7B, the fourth solar module 304 has been slid laterally along the length of the coupling clamp 100 so that the fourth solar module 304 resides substantially coincident with the spacer 105 and under a flange on third rail clamp 701. As a potential next step, fastener 106 is tightened to secure the coupling clamp 100 to the four solar modules and the third rail clamp 701 is tightened to secure the second solar module 301 and fourth solar module 304. As shown in this example embodiment, the spacer 105 may have a width substantially similar to third rail clamp 701 in order to create and maintain a substantially uniform gap width between a second solar module 301 and fourth solar module 304 upon installation. In other example embodiments, only a first and second solar module are installed, or only a first, second, and fourth solar module are installed, or only a first, second, third, and fourth solar module are installed with a coupling clamp 100.

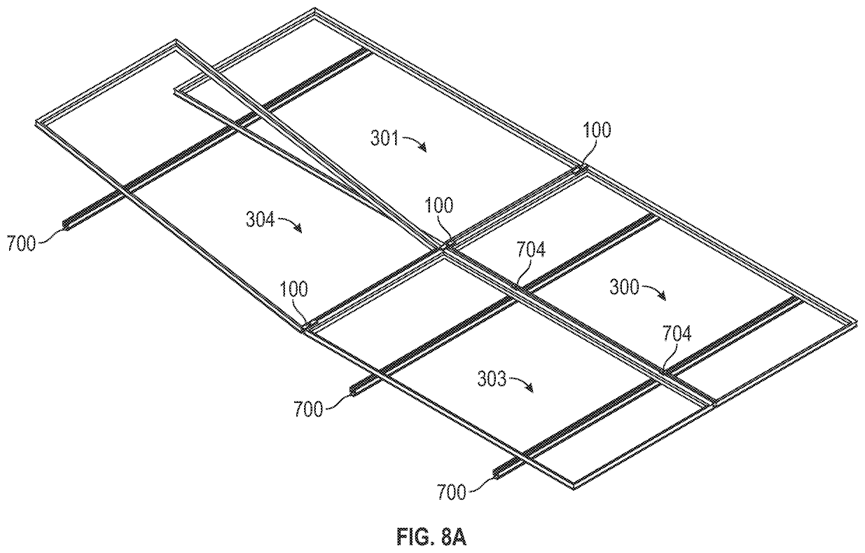

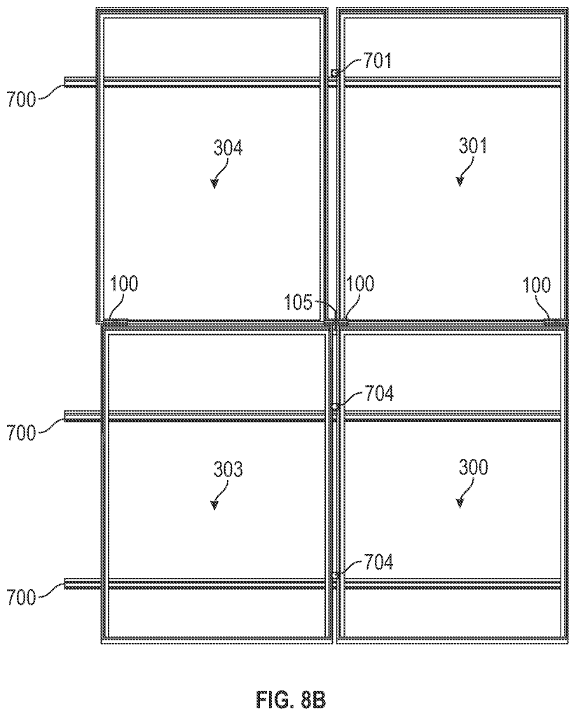

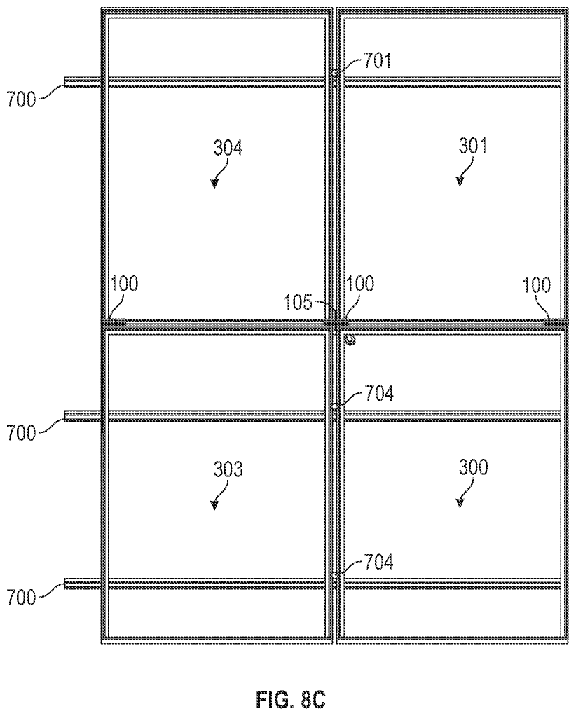

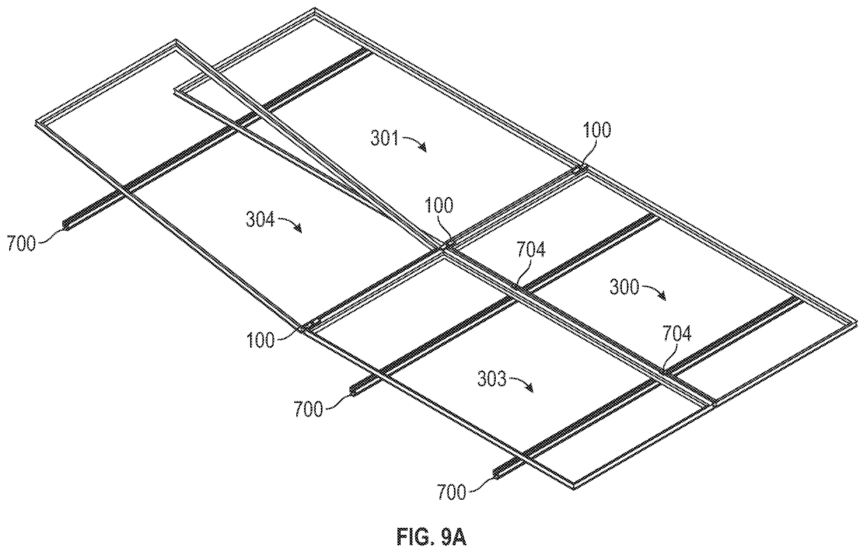

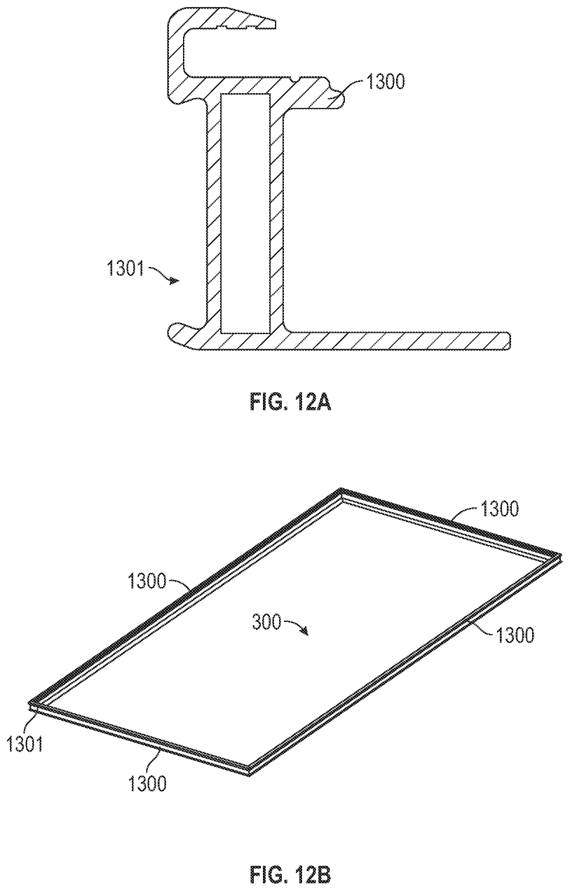

FIGS. 8A through 8C depict an alternative method of installation of the present invention. Unlike the example method described in FIGS. 7A through 7B, in this alternative embodiment, a third rail clamp 701 is installed in a third rail 700 and the third rail clamp 701 is positioned coincident to the second solar module 301. Third rail clamp 701 may not be tightened to compress onto the second solar module 301, but instead may be loose such that lateral flanges that protrude over the second solar module 301 are not clamping the second solar module 301. The fourth solar module 304 is positioned into a second engagement side 102 of one or more coupling clamps 100 and may be at an angle relative to adjacent solar modules as shown, such as second solar module 301. In FIG. 8C, the fourth solar module 304 is lowered to rest on the third rail 700, is substantially planar with one or more adjacent solar modules, and is offset laterally so as not to interfere with the third rail clamp 701. This offset distance may be equal to or larger than the length of the laterally protruding flange on the third rail clamp 701. In this position, the clamp engagement surface of the solar module, such as the top of the solar module frame or an upward-facing surface in a frame groove 1301 disposed in a solar module frame (see FIGS. 12-19), may be below the underside of the laterally protruding flanges on the third rail clamp 701. As a potential next step, the fourth solar module 304 is moved laterally to coincide with the third rail clamp 701 and spacer 105 on the coupling clamp 100. Then as a potential next step, the third rail clamp 701 is clamped to secure the second solar module 301 and fourth solar module 304 to the third rail 700, and coupling clamp 100 is clamped to secure all four solar modules together.

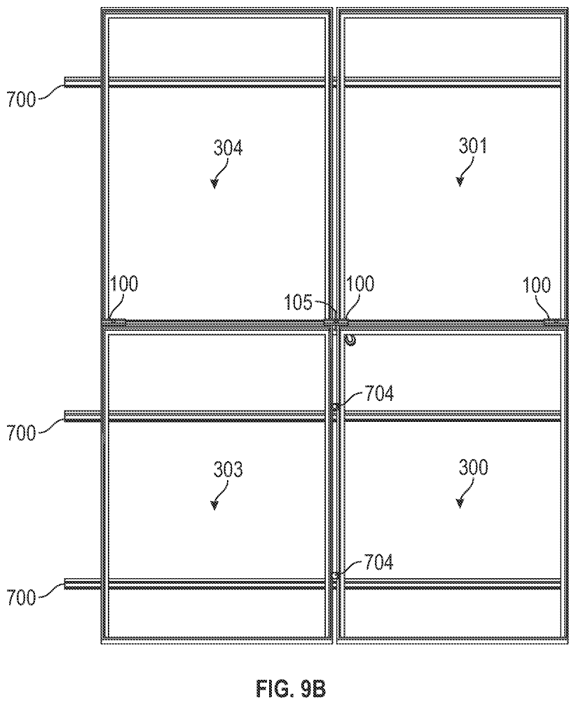

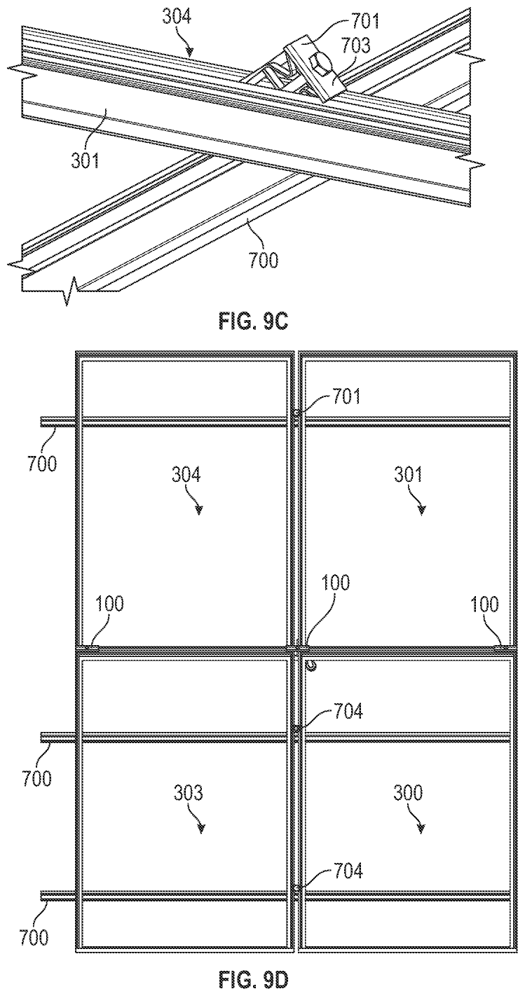

FIGS. 9A through 9D depict an alternative installation sequence of a fourth solar module in the second row of solar modules after a coupling clamp 100 has been installed onto the up-roof edge of a first row of one or more solar modules, representing another example method of installation of the present invention. As a first potential step, a coupling clamp 100 may be positioned on the up-roof edge of a first solar module 300 and potentially also a third solar module 303 in a position that will allow for spacer 105 to be coincident with the up-roof edge of a to-be-installed second solar module 301 or fourth solar module 304. Coupling clamp 100 may be secured to the one or more solar modules (e.g., first solar module 300 and the third solar module 303) in the first row of solar modules in a manner previously described. As a potential next step, the second solar module 301 may then be installed in a second engagement side 102 and positioned on to a third rail 700. As depicted in FIG. 9A, a fourth solar module 304 may then be installed into a second engagement side 102 of a coupling clamp 100 at an angle relative to the primary surface of adjacent solar modules 300, 303, and 301. The fourth solar module 304 may be positioned substantially coincident with spacer 105 while at an angle relative to the adjacent solar module 301, and a third rail clamp 701 may not yet be installed in a third rail 700. One or more additional rail clamps 704 may be installed in a first and second rail 700 as depicted.

FIG. 9B depicts the fourth solar module 304 lowered to be substantially planar with a second solar module 301 until it contacts the third rail 700, representing a potential next step in the installation process. FIG. 9C depicts a close-up isometric view of third rail clamp 701 being installed between the second solar module 301 and fourth solar module 304. Third rail clamp 701 may be inserted between the two solar modules at an angle, as shown, so that a nut on the underside of third rail clamp 701 is able to traverse into a channel of a rail 700 at an angle relative to the rail 700. Third rail clamp 701 may then be rotated to a vertical position such that the top flange 703 of the third rail clamp 701 is substantially parallel to the solar modules, and thereby allowing a nut to engage with a pair of flanges on the rail 701. Rail 700 may be a substantially U-shaped, and the flanges may protrude in towards the centerline rail 700 along its length or may protrude exteriorly away from the side vertical walls of the rail 700. Once the third rail clamp 701 is engaged to the rail 700, a fastener 106 on the third rail clamp 701 may be engaged to secure the solar module 304 to the rail 700 as shown in FIG. 9D. In the above example method of installation, the coupling clamp 100 may have been substantially clamped to the first row of solar modules such that no additional tightening of the coupling clamp 100 is necessary after the fourth solar module 304 is transitioned from an angled to a planar position relative to a second solar module 301.

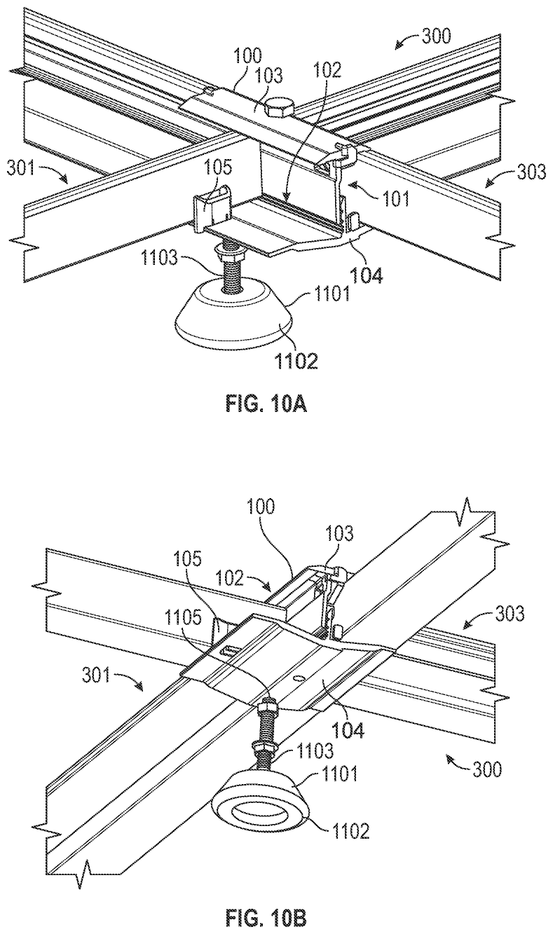

FIGS. 10A and 10B depict a height-adjustable support foot 1101 releasably connected to the coupling clamp 100 representing an example embodiment of the present invention. Support foot 1101 may consist of a support base 1102 connected to a support body 1103. Support body 1103 may be a threaded rod, a fastener, a tube, a solid rod, a rectangular beam, or another suitable geometry. Support base 1102 may be formed of an injection-molded polymer, plastic, polycarbonate, rubber, bonded metal and rubber, sheet metal, die-cast metal, machined metal, or other suitable material. In one example embodiment, support body 1103 is a threaded cylinder that threadably engages with the bottom clamp 104 at a threaded aperture 1105. Upon rotating support body 1103, the thread engagement with threaded aperture 1105 may cause support base 1102 to traverse towards or away from the bottom clamp 104, depending on the direction of rotation. In some example embodiments, support body 1103 may be disconnected from bottom clamp 104, yielding the coupling clamp 100 on its own as previously described herein. Support body 1103 may have a rotationally fixed connection to the support base 1102, or support body 1103 may freely spin around its primary axis relative to the support base 1102.

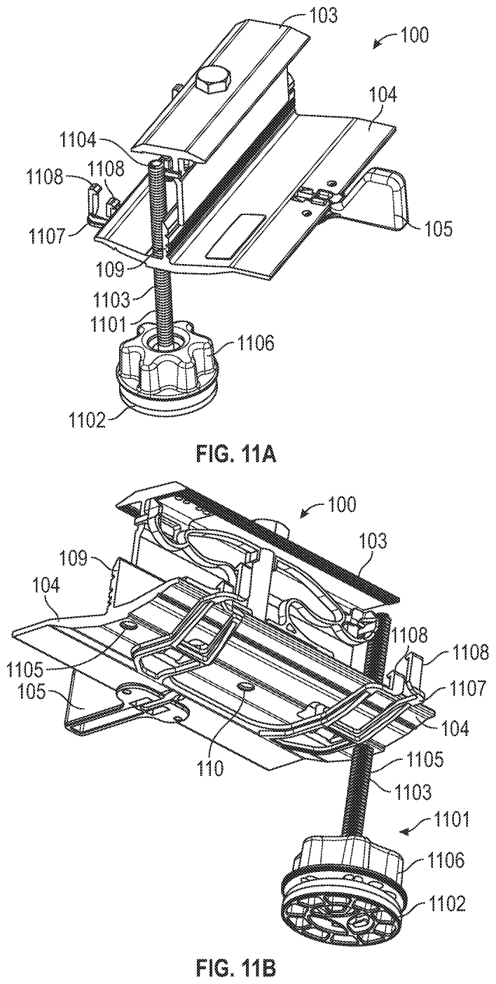

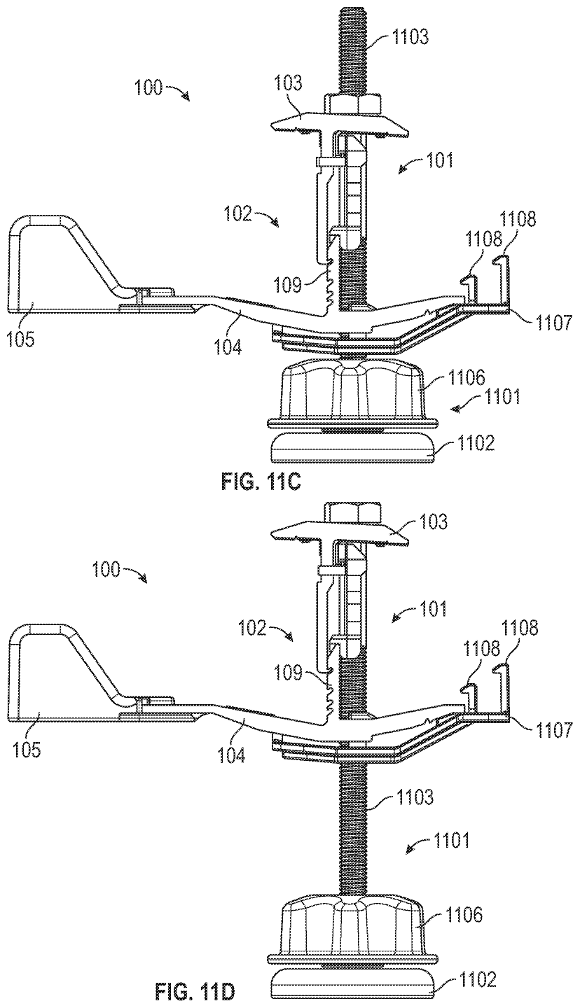

FIGS. 11A and 11B depict another example embodiment in which support body 1103 may connect to bottom clamp 104 via a bracket formed to cooperate with a geometry in bottom clamp 104, wherein the bracket releasably secures support body 1103 along its length in order to adjust the distance between bottom clamp 104 and support base 1102. In some example embodiments, support body 1103 is accessible to be adjusted after both a first engagement side 101 and second engagement side 102 of the coupling clamp 100 are occupied with one or more solar modules—either via an aperture disposed through the top surface of top clamp 103, support body 1103 connected to a portion of the bottom clamp 104 that extends beyond an end of the top clamp 103 as shown in FIG. 11A, support body 1103 extending through both the bottom clamp 104 and top clamp 103, or support body 1103 connected to a portion of top clamp 103 that extends beyond an end of bottom clamp 104. In such examples, and as shown in FIG. 11A, support body 1103 may have a tool engagement feature 1104 disposed on its distal end (such as a hex head or socket head) for engaging to adjust the height of the support foot 1101 relative to the coupling clamp 100. In the above example, support body 1103 is accessible for height adjustments relative to the coupling clamp 100 after one or more solar modules are installed into the First engagement side 101 and/or second engagement side 102 of the coupling clamp 100.

The support foot 1101 may be used on the coupling clamp 100 to provide structural compressive support between the coupling clamp 100 and an installation surface. As an example, in an installation process, support foot 1101 may be connected to a coupling clamp 100, and a coupling clamp 100 may be installed to one or more solar modules. Support foot 1101 may be adjusted in height relative to the coupling clamp 100 until the support foot 1101 coincides with the roof surface (e.g., the installation surface). In another example installation method, the coupling clamp 100 may be installed onto one or more solar modules in a first row of solar modules, such as on a first solar module 300 and third solar module 303, and then support foot 1101 is releasably secured to the coupling clamp 100. Then, support foot 1101 is adjusted to coincide with the roof surface. In yet a further example method of use, support foot 1101 is adjusted in height after one or more solar modules are installed in both the first engagement side 101 and second engagement side 102 of the coupling clamp 100.

FIGS. 11A through 11D depict various views of the coupling clamp 100 with a support foot 1101 installed, representing one example embodiment of the present invention. In this example embodiment, the support foot 1101 may have a hand-operable knob 1106 used to rotate support body 1103. Support body 1103 is threadably engaged with threaded aperture 1105 to traverse the support base 1102 towards or away from the coupling clamp 100. Support base 1102 may be rotationally fixed relative to the support body 1103 or may rotate freely along the axis of the support body 1103. In another example embodiment, support base 1102 may have one or more protrusions that engage with one or more protrusions on hand-operable knob 1106 to prevent the support body 1103 from freely rotating when support base 1102 is in contact with an installation surface. In another example embodiment, support base 1102 may have a butyl tape or a resilient, compressible member on the underside, such as a neoprene foam, to dampen or prevent the coupling clamp 100 from bouncing on the installation surface, such as during a variable wind speed event. FIG. 11C depicts a side view of coupling clamp 100 with the support foot 1101 in an upper position, and FIG. 11D depicts the same view but with the support foot 1101 in a lowered position.

The coupling clamp 100 may have a retention clip 1107 positioned on one or more sides of the laterally protruding flanges of the coupling clamp 100. As depicted, the retention clip 1107 may have one or more upwardly protruding retention flanges 1108 that extend above module flanges 201. The retention flanges 1108 are configured to engage the horizontal flange of a solar module so that the coupling clamp 100 does not readily fall off of a solar module prior to being clamped or tightened down using one or more fasteners 106. The retention clip 1107 may have one or more retention flanges 1108 positioned at different distances from the bottom vertical flange 109 in order to engage with different widths of horizontal flanges on different solar module frames, as shown.

FIG. 12A depicts an end view of a solar module frame 1300 with a frame groove 1301 disposed on the outside surface of the solar module frame 1300. Frame groove 1301 may take various shapes, such as a dovetail shape (as shown), a triangular, rectangular, or complex shape. Frame groove 1301 may have one or more clamp engagement surfaces on an interior portion of frame groove 1301. FIG. 12B depicts an isometric view of an assembled solar module frame with a frame groove 1301.

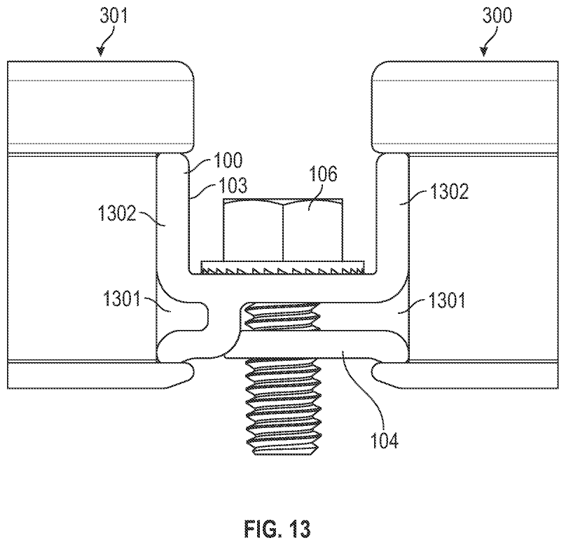

FIG. 13 depicts an end view of a coupling clamp 100 configured to engage with frame groove 1301 on a solar module 300. In this example embodiment, top clamp 103 has one or more vertical flanges 1302 which engage with an upper portion of frame groove 1301, and a bottom clamp 104 configured to engage with the lower portion of frame groove 1301. The bottom clamp 104 may engage with only one solar module frame or may engage with a pair of oppositely positioned solar module frames. The top clamp 103 may be formed as a single piece and engage with upper and lower surfaces of a frame groove 1301, and only the upper surface on a second solar module frame. Fastener 106 may threadably engage with the upper or lower body to secure the first solar module 300 to the second solar module 301.

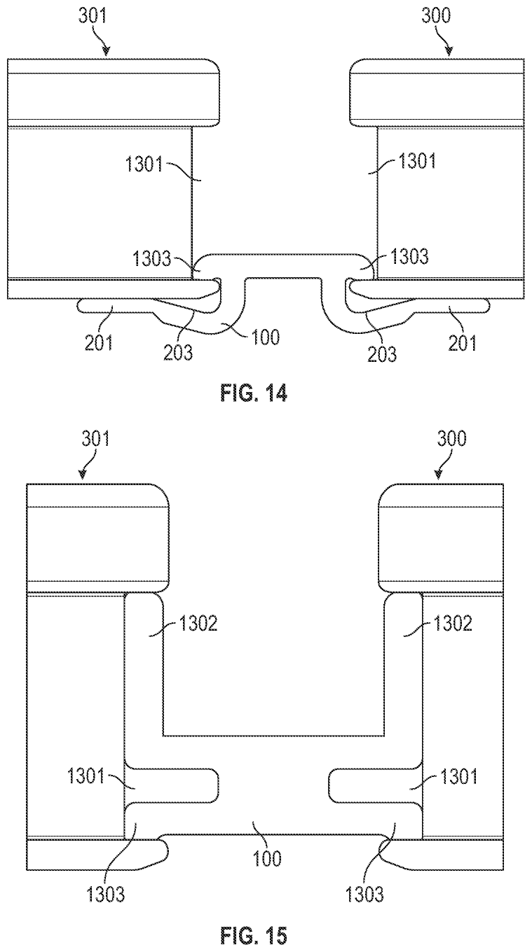

FIG. 14 depicts an alternative embodiment where coupling clamp 100 is configured to only engage a lower surface of frame groove 1301 and the underside of first solar module 300 and second solar module 301. FIG. 15 depicts another alternative where the coupling clamp 100 is formed as a single piece with vertical flanges 1302 configured to engage an upper surface and bottom grip flanges 1303 to engage a lower surface of frame groove 1301 on a first solar module 300 and second solar module 301. Vertical flanges 1302 and bottom grip flanges 1303 may have sufficient flex in order to engage into frame groove 1301 when installed at an angle, like in a cam-action, but not readily fall out. In this example, the coupling clamp 100 would be at a positive angle relative to first solar module 300, and then a top distal edge of a first vertical flange 1302 would engage with an upper interior surface of frame groove 1301. Then the coupling clamp 100 would be rotated around an axis near the top distal edge of a first vertical flange 1302 until the distal end of a first bottom grip flange 1303 engages with a lower interior surface of frame groove 1301.

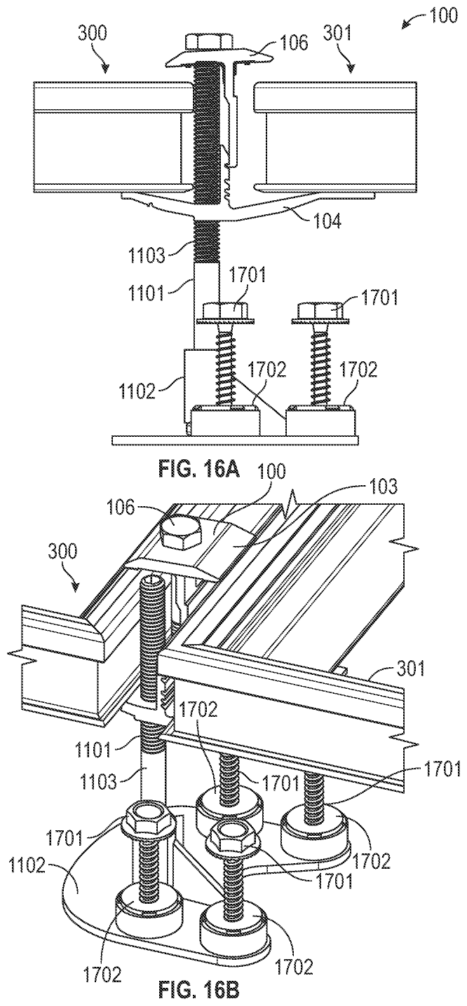

FIGS. 16A and 16B depict an alternative embodiment of the support foot 1101 where the support base 1102 includes one or more roof fasteners 1701 configured to secure support base 1102 to a roof surface. Support body 1103 may be free to rotate in support base 1102. Support base 1102 may have a water-sealing material disposed on the underside surface to seal the one or more roof fasteners 1701 at their respective penetrations into an installation surface from water intrusions, such as a Butyl, isobutyl, EPDM, neoprene, or other suitable material. In another example embodiment shown, one or more sealant capsules 1702 may be disposed on a top surface of support base 1102 and may compress sealant through one or more apertures in support base 1102 when a roof fastener 1701 is threadably engaged with a roof surface and compresses onto the top of the sealant capsule 1702. In this example embodiment, coupling clamp 100 may be installed on the up-roof edge of a first row of solar modules. Then the roof fasteners 1701 may be installed into the roof surface. Then a next row of solar modules may be installed into the second engagement side 102 of the coupling clamp 100.

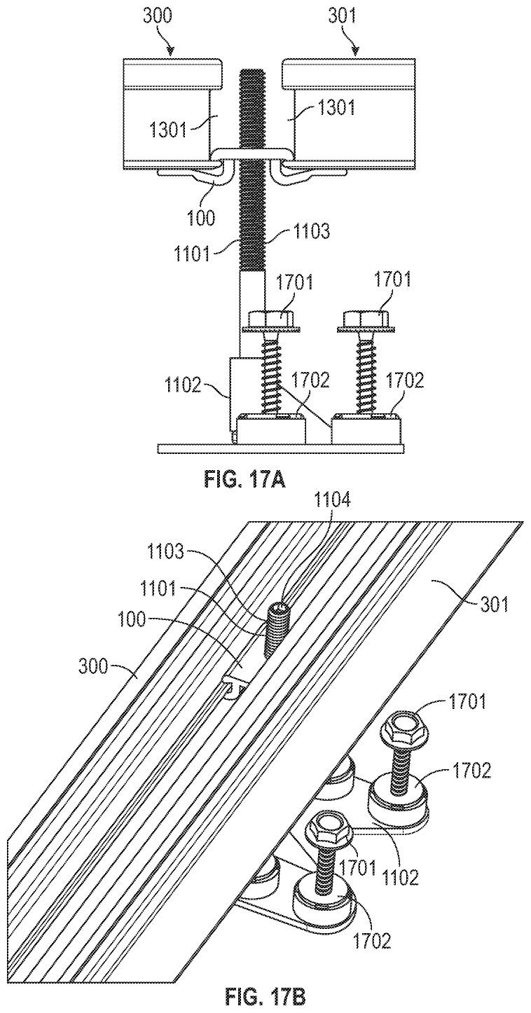

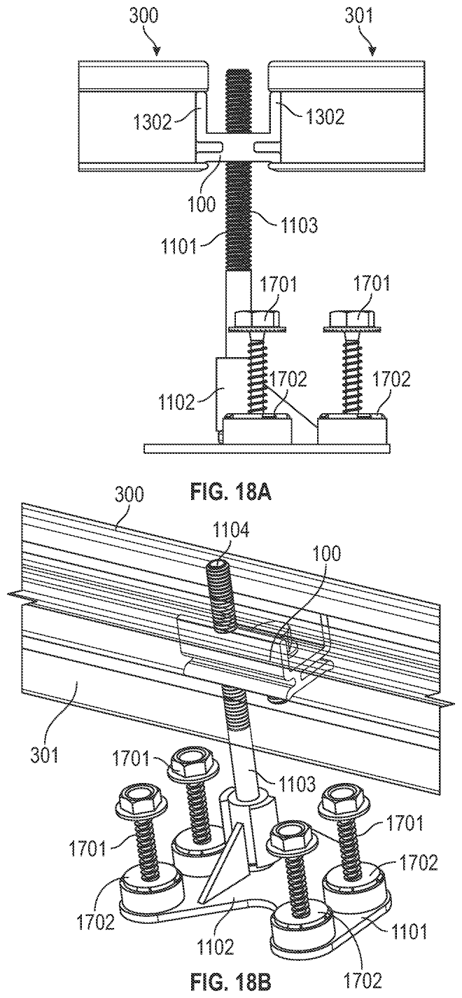

FIGS. 17A, 17B, 18A and 18B depict various views of the coupling clamp 100 configured to engage a frame groove 1301 with a support foot 1101 with roof fasteners 1701. Support body 1103 of the support foot 1101 may threadably engage with the coupling clamp 100 to lower or raise the coupling clamp 100 relative to the roof surface. Support body 1103 may have a tool engagement feature 1104 on the distal end configured to receive a tool for rotating the support body 1103. In some embodiments, tool engagement feature 1104 may be a hexagonal socket, a hexalobular, or other suitable shape. Tool engagement feature 1104 may be accessible after one or more solar modules are installed in a first engagement side 101 and second engagement side 102 of coupling clamp 100. Tool engagement feature 1104 may be below the top surface of the solar modules in order to conceal it from view. Tool engagement feature 1104 may also be offset from the side of the top clamp 103 on coupling clamp 100. The tool engagement feature 1104 may also be accessible through an aperture disposed in the top surface of the top clamp 103 in the coupling clamp 100.

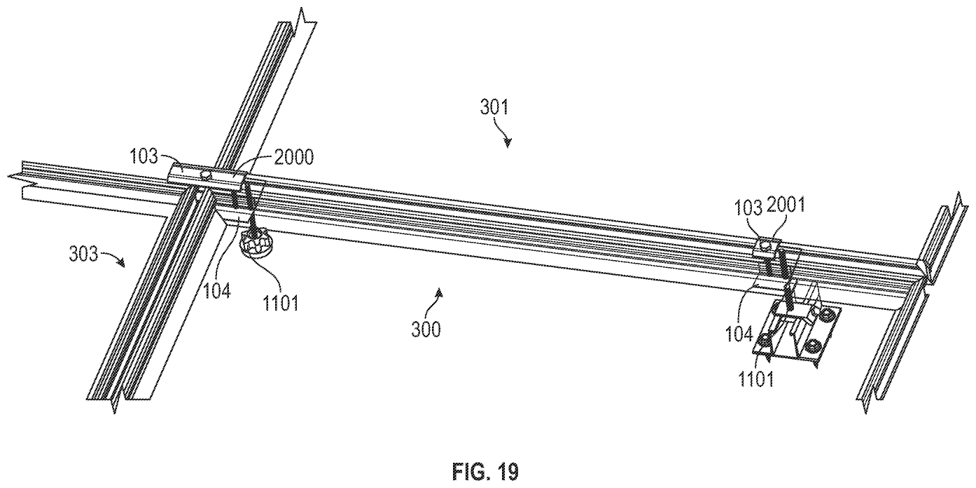

FIG. 19 depicts an isometric view close-up of a first solar module 300 and third solar module 303 in a first row of solar modules, and a second solar module 301 in a second row of solar modules. In this example embodiment, two versions of coupling clamps 100 are used to support the solar modules. A wide coupling clamp 2000 may be used to secure one or more solar modules in a first row and one or more solar modules in a second row. As depicted, wide coupling clamp 2000 secures a first solar module 300 and a third solar module 303 in a first row of solar modules, and only a second solar module 301 in a second row of solar modules. Wide coupling clamp 2000 may or may not include support foot 1101. As depicted, wide coupling clamp 2000 may be the same form as depicted in FIGS. 1 through 12. A short coupling clamp 2001 may be used to secure only a first solar module 300 and a second solar module 301 and may or may not include a support foot 1101. Top clamp 103 and bottom clamp 104 may have identical cross-sectional geometry in both wide coupling clamp 2000 and short coupling clamp 2001, only differing in their length and location of threaded apertures 110 and 1105.

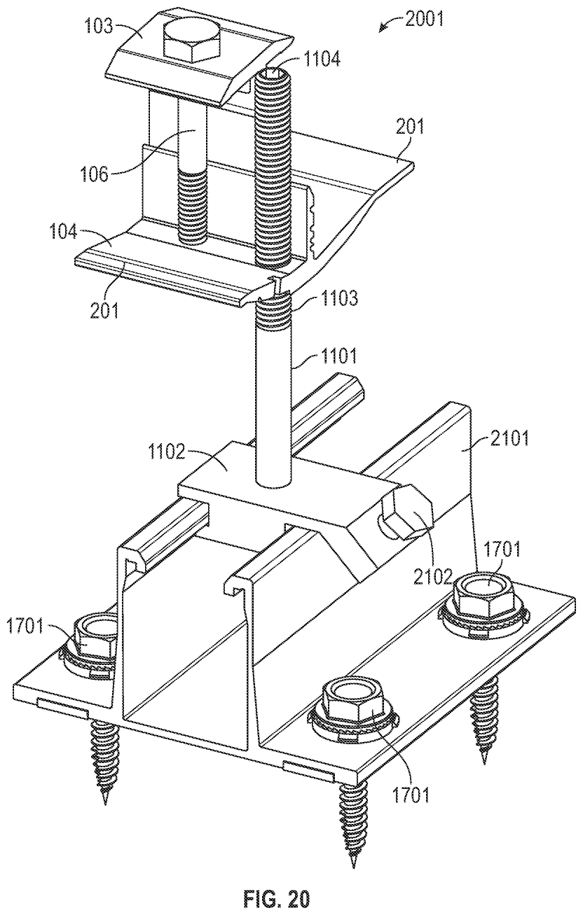

FIG. 20 is an isometric view of coupling clamp 2001 with a slidable support foot 1101, representing another example embodiment of the present invention. In this example embodiment, slider base 2101 has one or more roof fasteners 1701 configured to secure slider base 2101 to a roof surface. Support base 1102 is configured to slidably engage along an axis of slider base 2101. In this way, the coupling clamp 100 is able to laterally move along the length of the slider base 2101. Support base 1102 may have a slide-clamp feature, such as a lock fastener 2102, that tightens against the body of slider base 2101 to prevent the support base 1102 from traversing along the slider base 2101.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A coupling clamp comprising:
a top clamp that includes:
a top vertical flange, and
a top lateral flange that extends laterally from an upper distal end of the top vertical flange; and
a bottom clamp that includes:
a bottom vertical flange, and
a plurality of bottom lateral flanges that extend laterally in opposite directions from a bottom distal end of the bottom vertical flange, wherein at least one of the bottom lateral flanges has:
a first portion having a surface configured to engage with a solar module, and
a second portion connected to the bottom vertical flange at an intersection below the surface of the first portion, wherein the intersection is separated from a distal end of the top lateral flange by at least a horizontal distance.

2. The coupling clamp of claim 1, wherein the top lateral flange extends at an obtuse angle relative to the top vertical flange.

3. The coupling clamp of claim 2, wherein the top lateral flange extends at the obtuse angle on a same side of the coupling clamp as the at least one bottom lateral flange.

4. The coupling clamp of claim 1, wherein the top clamp and the bottom clamp are both symmetrical about a respective mid-plane.

5. The coupling clamp of claim 1, further comprising a spacer positioned at a distal end of the at least one bottom lateral flange and configured to maintain a gap between the solar module and another solar module on a same engagement side of the coupling clamp when the solar module and the other solar module are engaged by the coupling clamp.

6. The coupling clamp of claim 5, wherein the spacer is configured to avoid interfering with a horizontal frame member of the solar module when the solar module is fully installed.

7. The coupling clamp of claim 5, wherein a width of the spacer is substantially the same as a width of a rail clamp.

8. The coupling clamp of claim 1, further comprising:
one or more grooves spaced apart on the bottom vertical flange; and
a tooth of the top vertical flange, the tooth configured to cooperate with one of the grooves, wherein the vertical distance between the top clamp and the bottom clamp is based on the cooperation between the tooth and the cooperating groove and results in clamping of the solar module having a thickness that is one of 30 mm, 32 mm, 35 mm, and 40 mm.

9. The coupling clamp of claim 1, further comprising an electrical bonding feature that creates an electrical bond path with at least one solar module when the at least one solar module is engaged by the coupling clamp.

10. The coupling clamp of claim 1, further comprising a flexible resilient member configured to support the top clamp in position above the bottom clamp against a force of gravity and to flex when the top clamp is pushed down by a fastener.

11. The coupling clamp of claim 10, further comprising:
one or more grooves spaced apart on the bottom vertical flange; and
a tooth on the flexible resilient member, the tooth configured to cooperate with one of the grooves, wherein the vertical distance between the top clamp and the bottom clamp is based on the cooperation between the tooth and the cooperating groove and results in clamping of the solar module having a thickness that is one of 30 mm, 32 mm, 35 mm, and 40 mm.

12. The coupling clamp of claim 1, further comprising at least one fastener threadably engaged with a threaded aperture in the bottom clamp, wherein the at least one fastener clamps the top clamp and bottom clamp together when engaged with the threaded aperture.

13. The coupling clamp of claim 1, further comprising a retention clip that includes one or more tabs configured to aid in securing the coupling clamp to a first solar module before a second solar module is installed.

14. The coupling clamp of claim 1, further comprising a support base configured to traverse vertically relative to the coupling clamp in order to make contact with an installation surface.

15. A coupling clamp comprising:
a top clamp that includes:
a top vertical flange that has one or more teeth extending from a surface and a top aperture disposed through the top vertical flange, and
a top lateral flange that extends laterally from an upper distal end of the top vertical flange;
a bottom clamp that includes:
a bottom vertical flange that has one or more grooves configured to engage with the one or more teeth of the top vertical flange and a bottom aperture disposed through the bottom vertical flange, and
a plurality of bottom lateral flanges that extend laterally in opposite directions from a bottom distal end of the bottom vertical flange; and
a flexible locking member configured to be positioned in a locking position within the top aperture and the bottom aperture when the top aperture and the bottom aperture are aligned, wherein the flexible locking member prevents the top clamp and the bottom clamp from substantially sliding laterally when the flexible locking member is in the locking position.

16. The coupling clamp of claim 15, wherein the flexible locking member is configured to flex into a flexed position so as to avoid interference with the bottom vertical flange, wherein the flexible locking member allows the top clamp and the bottom clamp to be slid apart laterally when the flexible locking member is in the flexed position.

17. The coupling clamp of claim 15, further comprising a spacer positioned at a distal end of the bottom lateral flange and configured to maintain a gap between two solar modules when the solar modules are engaged on one engagement side by the coupling clamp.

18. The coupling clamp of claim 17, wherein the spacer is configured to avoid interfering with a horizontal frame member of a solar module when the solar module is fully installed.

19. The coupling clamp of claim 17, wherein a width of the spacer is substantially the same as a width of a rail clamp.

20. The coupling clamp of claim 15, wherein the one or more grooves are spaced apart on the bottom vertical flange, and wherein at least one of the teeth is configured to cooperate with one of the grooves, wherein the vertical distance between the top clamp and the bottom clamp is based on the cooperation between the at least one tooth and the cooperating groove and results in clamping of a solar module having a thickness that is one of 30 mm, 32 mm, 35 mm, and 40 mm.

21. The coupling clamp of claim 15, further comprising an electrical bonding feature that creates an electrical bond path with at least one solar module when the at least one solar module is engaged by the coupling clamp.

22. A method of installing a solar module, the method comprising:
positioning a coupling clamp onto a first solar module, a second solar module, and a third solar module, wherein the second solar module is supported on an opposite half by a rail;
installing a rail clamp to the rail, wherein a portion of the installed rail clamp extends over the second solar module;
positioning a fourth solar module into the coupling clamp and onto the rail;
sliding the fourth solar module laterally until the fourth solar module is positioned under a portion of the rail clamp; and
tightening the rail clamp to clamp the fourth solar module to the rail.

23. The method of claim 22, further comprising tightening the coupling clamp to secure at least the fourth solar module.

24. The method of claim 22, wherein the coupling clamp includes a top clamp and a bottom clamp, and further comprising initially setting the coupling clamp in accordance with a thickness of the solar modules by using one or more engagements between one or more corresponding teeth of the top clamp and grooves of the bottom clamp.

25. The method of claim 22, further comprising lowering a support base until the support base is in contact with an installation surface before the second solar module or the fourth solar module is installed.

26. A method of installing a solar module, the method comprising:
positioning a coupling clamp onto a first solar module, a second solar module, and a third solar module, wherein the second solar module is supported on an opposite half by a rail;
positioning a fourth solar module into the coupling clamp and onto the rail;
installing a rail clamp to the rail, wherein a portion of the installed rail clamp extends over the second solar module and the fourth solar module; and
tightening the rail clamp to clamp the fourth solar module to the rail.

27. The method of claim 26, wherein the coupling clamp includes a top clamp and a bottom clamp, and further comprising initially setting the coupling clamp in accordance with a thickness of the solar modules by using one or more engagements between one or more corresponding teeth of the top clamp and grooves of the bottom clamp.

28. The method of claim 26, wherein the first solar module and the third solar module are installed on one engagement side of the coupling clamp, and the second solar module and a fourth solar module are installed onto an opposite engagement side of the coupling clamp, wherein both the second solar module and the fourth solar module are in contact with a spacer disposed therebetween.

29. The method of claim 25, further comprising lowering a support base until the support base is in contact with an installation surface before the second solar module or the fourth solar module is installed.
